(19) United States
(12) Patent Application Publication
(10) Pub. No.: US 2003/0014261 A1
(43) Pub. Date: Jan. 16, 2003

(54) Information input method and apparatus

(76) Inventor: Hiroaki Kageyama, Iwaki-city (JP)

Correspondence Address: BRINKS HOFER GILSON & LIONE, P.O. BOX 10395, CHICAGO, IL, 60611, US

(21) Appl. No.: 10/177,617

(22) Filed: Jun. 20, 2002

(30) Foreign Application Priority Data
Jun. 20, 2001 (JP) 2001-186067

(51) Int. Cl. G10L 21/00

(52) U.S. Cl. 704/275

(57) ABSTRACT

An apparatus has both a function to enter a plurality of items required for processing by means of key input by repeating an operation in which an item is selected from a displayed list using a key selection, which causes the display of another list of items related to the selected item, and a function to enter a plurality of items required for processing by means of voice input by entering each item via voice. An item may be entered by a combination of key input and voice input. When an item is entered by either key input or voice input, a list of items related to the entered item is displayed. Alternatively, upon a request for list view in a voice-input mode, a list of items for key input is presented, and the input mode is temporarily switched to a key-input mode. Once an item has been selected from the presented list using a key selection, the input mode is returned to the voice-input mode.

### BACKGROUND OF THE INVENTION

The present invention generally relates to information input methods and apparatuses. More particularly, the present invention relates to an information input apparatus having both a function to enter information required for processing by means of key input by repeating an operation in which an item is selected from a displayed list of items using a key selection, which causes the display of another list of items related to the selected item, and a function to enter information required for processing by means of voice input by entering each item via voice. The present invention also relates to an information input method.

In some information input apparatuses, information required for processing is classified into a plurality of items, and the desired items are sequentially input so that the required information is entered. Approaches for entering an item include a key-input method and a voice-input method. In the key-input method, information required for processing is entered by repeating an operation in which a list of items is displayed and a desired item is selected from the list by a key selection, which causes the display of another list of items related to the selected item. In the voice-input method, information required for processing is entered by means of voice input by entering each item via voice.

FIG. 11 illustrates (a) a key-input method, and (b) a voice-input method by which a destination is input in a navigation system.

For example, a destination is entered by key input according to the following procedure:

(1) A main menu is displayed, on which a “Set Destination” command is highlighted using a key operation or is selected by shifting a select bar.

(2) Once the “Set Destination” command has been selected, a list of commands indicating methods used to find the destination is displayed, and a desired method, such as “Category”, is selected in the same way using a key operation.

(3) Once the “Category” command has been selected, a list of commands indicating categories is displayed, and a desired category, such as “Golf Courses”, is selected using a key operation.

(4) Once the “Golf Courses” command has been selected, a list of commands indicating prefectures is displayed, and the prefecture where a desired golf course is located, such as “Fukushima”, is selected.

(5) Once the “Fukushima” command has been selected, a list of commands indicating golf courses (facilities) located in the Fukushima prefecture is displayed, and a desired golf course, such as “Onahama C.C.”, is selected. Then, a set key is pressed, and “Onahama C.C.” is accepted as the destination by the system.

In order to enter a destination by voice input, the same items entered using key input, as described above, are sequentially input via voice. Specifically, “DESTINATION”, “CATEGORY”, “GOLF”, “FUKUSHIMA”, and “ONAHAMA” are sequentially input via voice. Finally, “SET” is input via voice, and “Onahama C.C.” is accepted as the destination by the system. It is noted that a talk switch should be turned on before each item is spoken and entered via voice.

The key-input method is advantageous in that information such as a destination can be accurately entered, but has disadvantages in that the key operations are cumbersome and inputting information is time-consuming.

On the other hand, the voice-input method is advantageous in that information can be entered with ease, but provides imperfect speech recognition, which may result in incorrect recognition and require a user to re-enter items. In particular, when more specific items, such as prefecture name and facilities name, are to be entered, there are often many selections available or many items resembling the desired item, possibly leading to incorrect recognition. Another disadvantage associated with the voice-input method is that items cannot be entered if the point of interest, such as the prefecture in which the destination is located, or the facilities located at the destination, is unknown.

### BRIEF SUMMARY OF THE PREFERRED EMBODIMENTS

Accordingly, it is an object of the present invention to provide an information input apparatus and method having both key input and voice input functions to overcome the problems associated with these methods in the conventional art.

To this end, according to one aspect of the present invention, an information input method is provided for an apparatus having a key-input function to enter information required for processing by means of key input by repeating an operation in which an item is selected from a displayed list of items using a key selection, which causes the display of a list of items related to the selected item, and a voice-input function to enter information required for processing by means of voice input by entering each item via voice is provided. The method includes: entering an item by a combination of key input and voice input; and, when an item is entered by either the key input and voice input, displaying a list of items related to the entered item.

This aspect of the invention enables items to be entered by either key input or voice input at any time. An item can be accurately entered on list view, using key input, if an item entered via voice is not successfully recognized or could be incorrectly recognized.

According to another aspect of the present invention, an information input method is provided for an apparatus having a key-input mode in which information required for processing is entered by means of key input by repeating an operation in which an item is selected from a displayed list of items using a key selection, which causes the display of a list of items related to the selected item, and a voice-input mode in which information required for processing is entered by means of voice input by entering each item via voice. The method includes: allowing a user to request a list view in the voice-input mode; presenting a list of items for key input upon the request, while temporarily switching the input mode to the key-input mode; and returning the input mode to the voice-input mode once an item has been selected from the displayed list via key selection.

According to another aspect of the present invention, an information input method is provided for an apparatus having a key-input mode in which information required for processing is entered by means of key input by repeating an operation in which an item is selected from a displayed list of items using a key selection, which causes the display of a list of items related to the selected item, and a voice-input mode in which information required for processing is entered by means of voice input by entering each item via voice. The method includes: allowing a user to request a list view in the voice-input mode; displaying a list of items for key input upon the request, while switching the input mode to the key-input mode; and returning the input mode to the voice-input mode once an item has been selected from the displayed list via key selection.

According to another aspect of the present invention, an information input apparatus is provided having a key-input mode in which information required for processing is entered by means of key input by repeating an operation in which an item is selected from a displayed list of items using a key selection, which causes the display of a list of items related to the selected item, and a voice-input mode in which information required for processing is entered by means of voice input by entering each item via voice. The apparatus includes: a unit for outputting a request to temporarily switch the input mode from the voice-input mode to the key-input mode; a unit for, upon receiving the appropriate request in the voice-input mode, switching the input mode from the voice-input mode to the key-input mode to display a list of items for key input; and a unit for returning the input mode to the voice-input mode once an item has been selected from the displayed list via key selection.

According to another aspect of the present invention, an information input apparatus is provided having a key-input mode in which information required for processing is entered by means of key input by repeating an operation in which an item is selected from a displayed list of items using a key selection, which causes the display of a list of items related to the selected item, and a voice-input mode in which information required for processing is entered by means of voice input by entering each item via voice. The apparatus includes: a unit for outputting a request to temporarily switch the input mode from the key-input mode to the voice-input mode; and a unit for returning the input mode to the key-input mode once an item has been selected via voice input.

Therefore, if an item entered via voice is not recognized or could be incorrectly recognized, the input mode is temporarily switched to the key-input mode, in which an item can be accurately entered on list view. Because the input mode is returned to the voice-input mode after the item has been successfully entered via key input, subsequent information can be input via the voice-input mode.

According to another aspect of the present invention, an information input apparatus is provided having a key-input mode in which information required for processing is entered by means of key input by repeating an operation in which an item is selected from a displayed list of items using a key selection, which causes the display of a list of items related to the selected item, and a voice-input mode in which information required for processing is entered by means of voice input by entering each item via voice. The apparatus includes: a unit for outputting a request to switch the input mode from the voice-input mode to the key-input mode; and a unit for, upon receiving the appropriate request in the voice-input mode, switching the input mode from the voice-input mode to the key-input mode to present a list of items for key input, wherein an item may be entered via key input.

Therefore, if an item entered via voice is incorrectly recognized, or when more detailed items are entered which are likely to be incorrectly recognized, the input mode is switched from the voice-input mode to the key-input mode, in which items may be entered accurately via key input.

According to another aspect of the present invention, an information input apparatus is provided having a key-input mode in which information required for processing is entered by means of key input by repeating an operation in which an item is selected from a displayed list of items using a key selection, which causes the display of a list of items related to the selected item, and a voice-input mode in which information required for processing is entered by means of voice input by entering an item via voice. The apparatus includes: a unit for outputting a request to switch the input mode from the key-input mode to the voice-input mode; and a unit for, upon receiving the appropriate request in the key-input mode, switching the input mode from the key-input mode to the voice-input mode, wherein an item may be entered via voice input.

### BRIEF DESCRIPTION OF THE DRAWINGS

FIG. 1 is a block diagram of the overall structure of a navigation system according to one presently preferred embodiment of the invention;

FIG. 2 is a block diagram of a navigation control apparatus;

FIG. 3 is a block diagram of a speech recognition apparatus;

FIG. 4 is a diagram that illustrates an information input method according to a first presently preferred embodiment of the invention;

FIG. 5 is a diagram that illustrates an information input method according to a second presently preferred embodiment of the invention;

FIG. 6 is a diagram that illustrates an information input method according to a third presently preferred embodiment of the invention;

FIG. 7 is a diagram that illustrates an information input method in a setting/editing process;

FIG. 8 is a flowchart that shows an information input procedure according to the first embodiment;

FIG. 9 is a flowchart that shows an information input procedure according to the second embodiment;

FIG. 10 is a flowchart that shows an information input procedure according to the third embodiment; and

FIG. 11 is a diagram that illustrates a method for entering a destination in a navigation system.

### DETAILED DESCRIPTION OF THE PREFERRED EMBODIMENTS

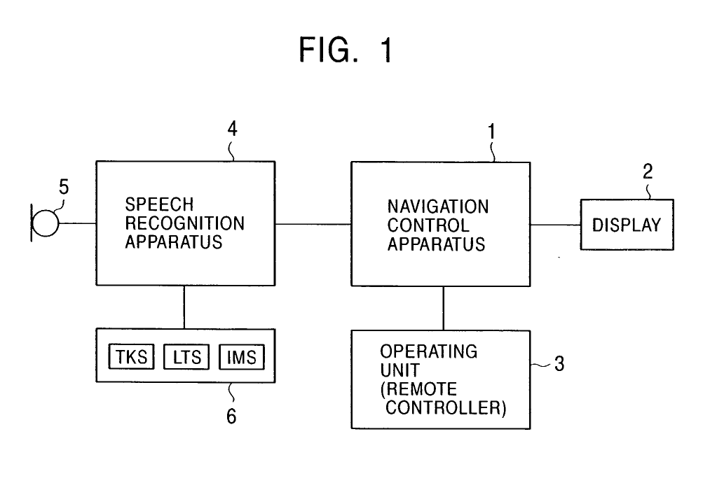

FIG. 1 shows the overall structure of a navigation system according to one presently preferred embodiment of the invention.

The navigation system includes a navigation control apparatus 1 for navigation control, a display device 2 for displaying maps, menus, etc., an operating unit 3 for navigation, such as a remote controller, a speech recognition apparatus 4, which allows information recognized by speech recognition to be input to the navigation control apparatus 1, a microphone 5 for detecting words spoken by a user, and an operating unit 6 for the speech recognition apparatus 4. The operating unit 6 includes a talk switch TKS. The operating unit (remote controller) 3 has various keys that are activated to select menus for various settings and instructions that are activated to enter the name of the point of interest, scale the area around the point of interest up and down, etc. One of the operating units 3 and 6 includes a list switch LTS which is turned on to request list view, and an input-mode switch IMS which is turned on to request input-mode switching. In the embodiment illustrated in FIG. 1, the operating unit 6 includes the switches LTS and IMS.

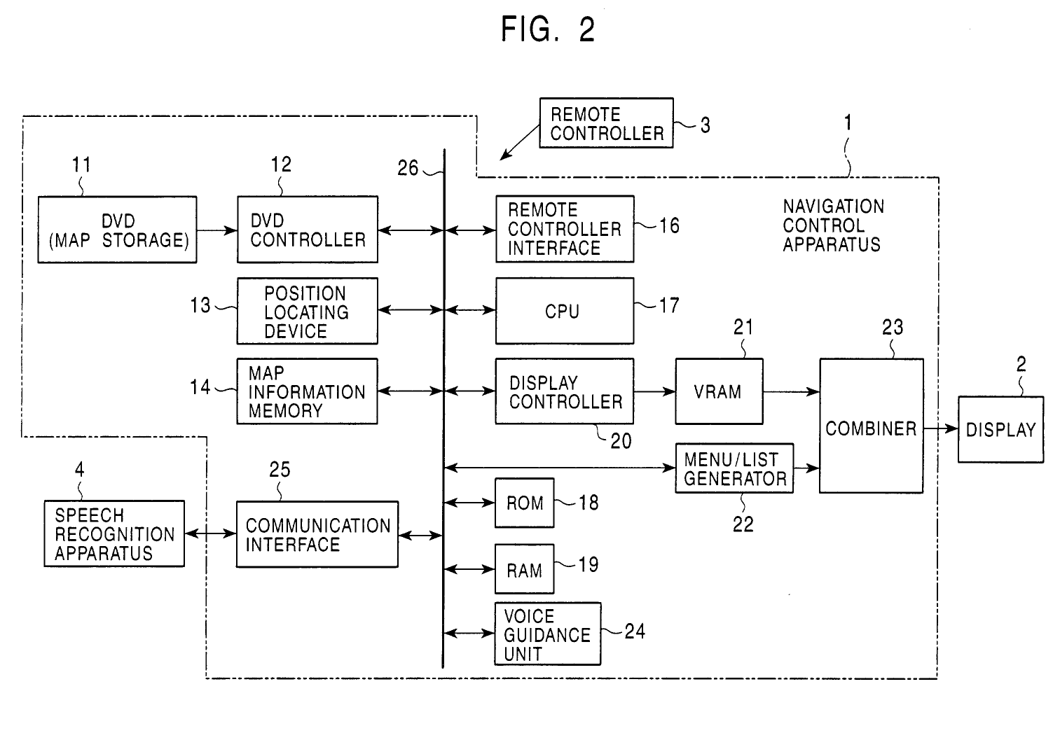

FIG. 2 is a block diagram of the navigation control apparatus 1.

The navigation control apparatus 1 includes a map storage medium 11, such as a DVD (digital video disc), for storing map information, a DVD controller 12 for reading map information from the DVD 11, and a position locating device 13 for locating the current vehicle position. The position locating device 13 includes a speed sensor for detecting the travel distance, an angular speed sensor for detecting the traveling direction, a GPS (global positioning system) receiver, and a CPU (central processing unit) for calculating the vehicle position. The navigation control apparatus 1 further includes a map information memory 14 for storing map information, read from the DCD 11 pertaining to the vicinity of the vehicle position, and a remote controller interface 16.

The navigation control apparatus 1 further includes a CPU or a navigation controller 17 for controlling the overall navigation control apparatus 1, a ROM (read-only memory) 18 for storing software (loading program) for downloading various control programs from the DVD 11, a RAM (random access memory) 19 for storing the various control programs downloaded from the DVD 11, such as a destination setting program DSP and a route search program RSP, guide route data, and other processing results. Additionally, the navigation control apparatus 1 includes a display controller 20 which generates map images, guide routes, etc., and a video RAM 21 for storing the image generated by the display controller 20, a menu/list generator 22 for generating various menus and lists, an image combiner 23 for combining various images before the combined image is output to the display device 2, a voice guidance unit 24 for providing audio guide information, including the distance to an intersection and the traveling direction, and a communication interface 25 for transmitting and receiving data to and from the speech recognition apparatus 4. The components are communicate a bus 26.

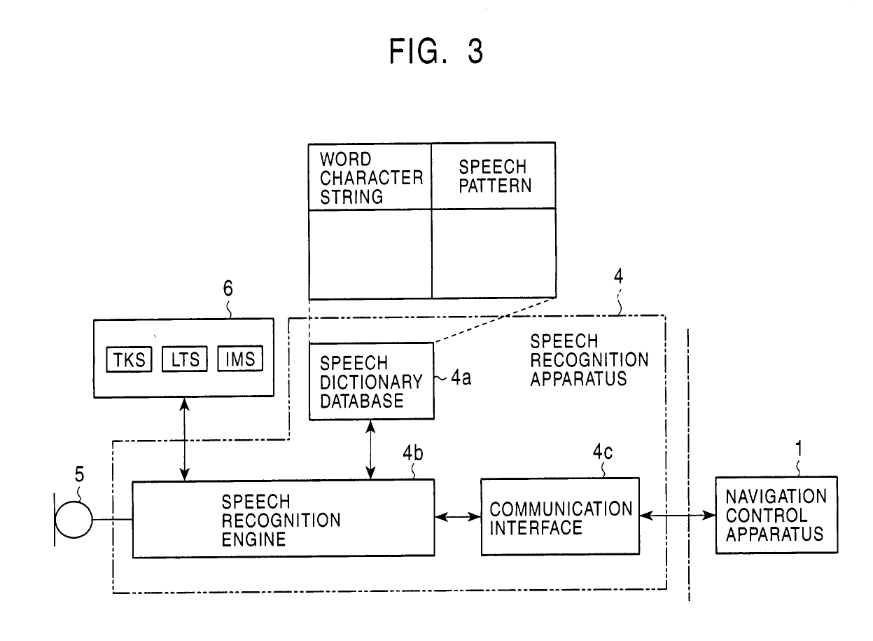

FIG. 3 is a block diagram of the speech recognition apparatus 4.

The speech recognition apparatus 4 includes a speech dictionary database 4a for storing the character string of words and the speech patterns of the words, which are associated with each other, a speech recognition engine 4b for retrieving and outputting a character string associated with the speech pattern which is closest to the words entered using the microphone 5 according to speech pattern matching, and a communication interface 4c for transmitting and receiving data to and from the navigation control apparatus 1.

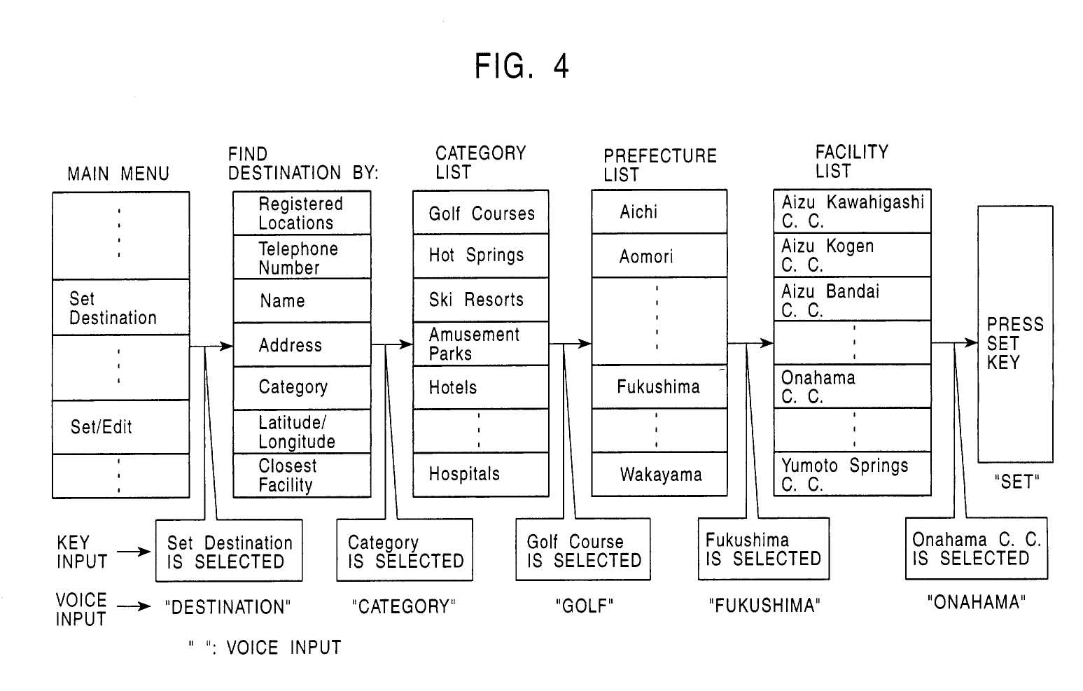

FIG. 4 illustrates an information input method according to the first presently preferred embodiment of the invention, which is suitable for inputting a destination.

According to the first embodiment, an item can be entered by a combination of key input and voice input at any time. When an item is entered by either key input or voice input, the item is accepted and a list of items related to the item is presented. More specifically, in the first embodiment, a destination is entered according to the following procedure:

(1) A main menu is displayed, on which a “Set Destination” command is highlighted by a key operation, or “DESTINATION” is input via voice after the talk switch TKS is turned on.

(2) Once the “Set Destination” command has been selected using a key selection, or “DESTINATION” has been input via voice, a list of commands indicating methods used to find the destination is displayed. Then, a desired method, such as “Category”, is selected in the same way using a key operation, or “CATEGORY” is input via voice after the talk switch TKS is turned on.

(3) Once the desired category has been selected using a key selection, or “CATEGORY” has been input via voice, a list of commands indicating categories is displayed. Then, a desired category, such as “Golf Courses”, is selected by a key operation, or “GOLF” is input via voice after the talk switch TKS is turned on.

(4) Once the “Golf Courses” command has been selected using a key selection, or “GOLF” has been input via voice, a list of commands indicating prefectures is displayed. Then, the prefecture where a desired golf course is located, such as “Fukushima”, is selected using a key selection, or “FUKUSHIMA” is input via voice after the talk switch TKS is turned on.

(5) Once the “Fukushima” command has been selected using a key selection, or “FUKUSHIMA” has been input via voice, a list of commands indicating golf courses (facilities) located in the Fukushima prefecture is displayed. Then, a desired golf course, such as “Onahama C.C.”, is selected, and a set key is pressed. Alternatively, after the talk switch TKS is turned on, “ONAHAMA” is input via voice, and “SET” is input via voice.

Thus, “Onahama C.C.” is accepted as the destination by the system.

In the information input method according to the first embodiment, an item can be entered by either key input or voice input at any time, thereby enabling an item to be accurately entered on list view by key input if speech recognition is not successful or if incorrect recognition is likely to occur.

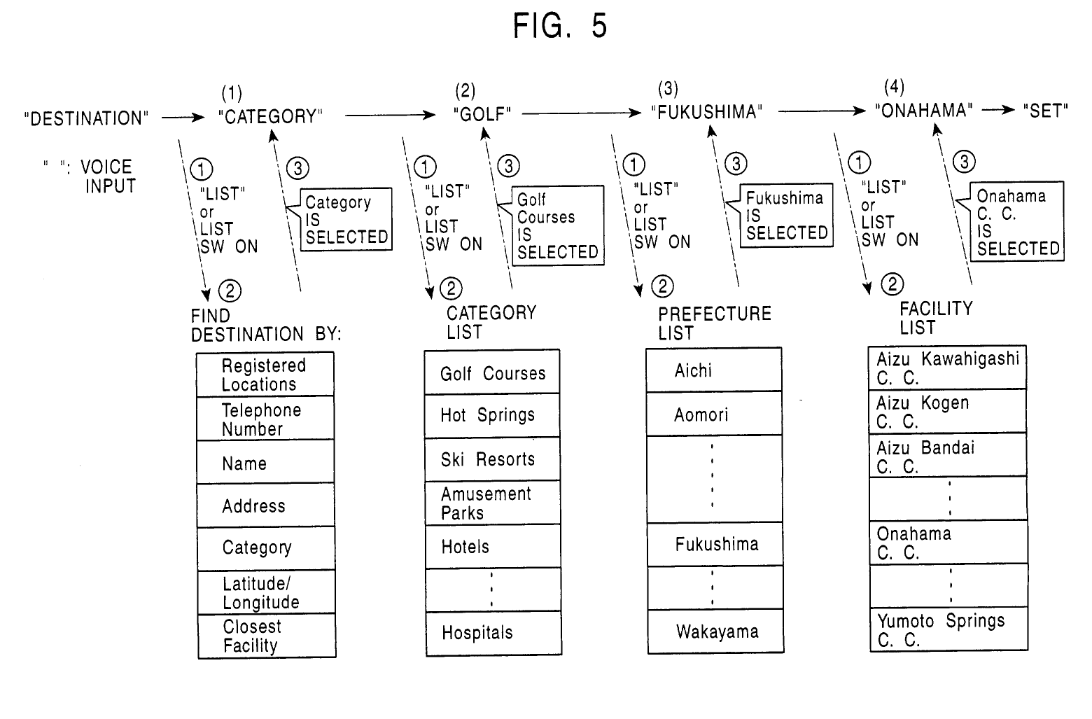

FIG. 5 illustrates an information input method according to the second presently preferred embodiment of the invention, which is suitable for inputting a destination.

According to the second embodiment, the input mode is temporarily switched from voice-input mode to key-input mode, and then returned to voice-input mode once an item has been selected from a displayed list of items. More specifically, in the second embodiment, in order to input a destination, a request for list view is issued in the voice-input mode, and a list of items for key input is presented upon the request. At this time, the input mode is temporarily switched from the voice-input mode to the key-input mode. Once an item has been selected by a key operation from the presented list, the input mode is returned to the voice-input mode, in which subsequent items are input.

In an event (1) shown in FIG. 5, “DESTINATION” is input via voice after the talk switch TKS is turned on. Then, “LIST” is input via voice, or the list switch LTS is turned on, to request list view. Upon the request, a list of items indicating methods used to find the destination is displayed, and “Category” is selected from the list by a key operation. The input mode is then returned to the voice-input mode.

In an event (2) shown in FIG. 5, after “Category” has been selected, “LIST” is input via voice, or the list switch LTS is turned on, to request list view. Upon the request, a list of items indicating categories is presented, and “Golf Courses” is selected from the list by a key operation. The input mode is then returned to the voice input mode.

In an event (3) shown in FIG. 5, after “Golf Courses” has been entered, “LIST” is input via voice, or the list switch LTS is turned on, to request list view. Upon the request, a list of items indicating prefectures is presented, and “Fukushima” is selected from the list by a key operation. The input mode is then returned to the voice-input mode.

In an event (4) shown in FIG. 5, after “Fukushima” has been entered, “LIST” is input via voice, or the list switch LTS is turned on, to request list view. Upon the request, a list of items indicating facilities is presented, and “Onahama C.C.” is selected from the list by a key operation. The input mode is then returned to the voice-input mode.

According to the third embodiment, therefore, if incorrect recognition occurs, or is likely to occur, in speech recognition, the input mode is temporarily switched to the key-input mode, in which an item can be accurately entered from a list of items.

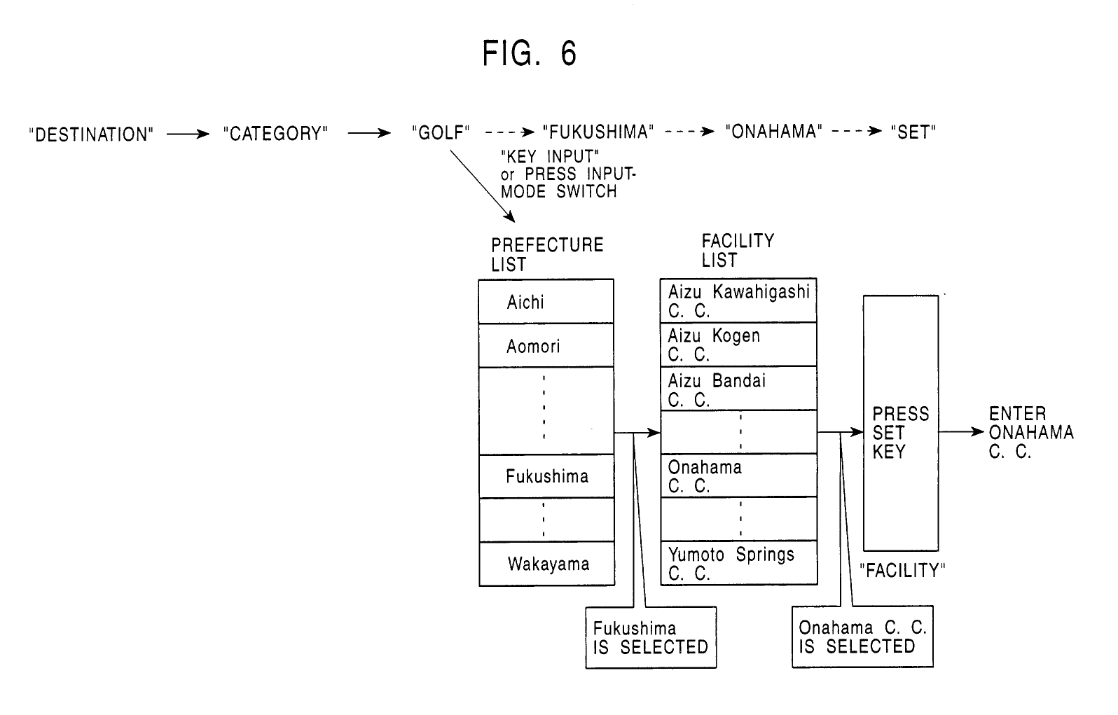

FIG. 6 illustrates an information input method according to the third presently preferred embodiment of the invention, which is suitable for inputting a destination.

According to the third embodiment, the input mode is switched from the voice-input mode to the key-input mode upon a request, and subsequent items are entered via key input. In FIG. 6, the input mode is switched from voice-input mode to key-input mode when the “Prefecture” item is entered, but the input mode may be switched at any time.

In order to enter a destination by voice input, “DESTINATION”, “CATEGORY”, and “GOLF” are sequentially input via voice, followed by “FUKUSHIMA”. However, the speech recognition apparatus 4 might incorrectly recognize the word (for example, “Fukushima” may be recognized as “Fukuoka”). In order to avoid such incorrect recognition, “KEY INPUT” may be input via voice, or the input-mode switch IMS may be pressed to switch the input mode from voice-input mode to key-input mode. The input-mode switching allows a prefecture list to be presented, from which “Fukushima” may be selected via key selection. After “Fukushima” has been selected using a key selection, a list of items indicating golf courses (facilities) located in the Fukushima prefecture is displayed. Then, a desired golf course, such as “Onahama C.C.”, is selected, and the set key is pressed. Thus, “Onahama C.C.” is accepted as the destination by the system.

In the information input method of the third embodiment, therefore, if incorrect speech recognition occurs, or when more detailed items are entered which are more likely to result in incorrect recognition, the input mode may be switched from voice-input mode to key-input mode, in which an item can be entered accurately via the list view.

Although the previous embodiments have been described with reference to entry of a destination, the present invention is not limited thereto, and may be applied to the entry of other types of information.

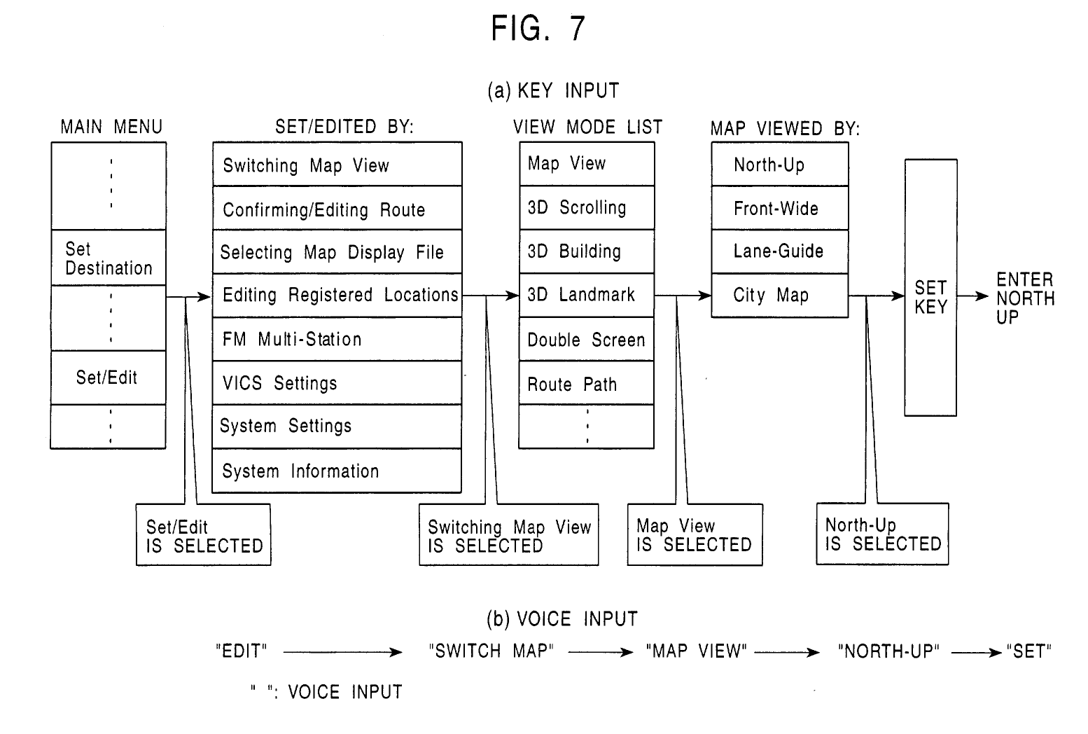

FIG. 7 shows information input methods, namely, a key-input method (a) and a voice-input method (b), in a setting/editing process.

A procedure to allow a map to be oriented with north pointed up may be as follows:

(1) A main menu is displayed, on which a “Set/Edit” command is highlighted by a key operation or is selected by shifting a select bar.

(2) Once the “Set/Edit” command has been selected, a list of commands indicating methods used for set/edit operation is displayed, and a desired method, such as “Switching Map View”, is selected by a key operation.

(3) Once the “Switching Map View” command has been selected, a list of commands indicating view modes is displayed, and a desired view mode, such as “Map View”, is selected by a key operation.

(4) Once the “Map View” command has been selected, a list of commands indicating methods used to view the map is displayed, and a desired method, such as “North-Up”, is selected. Then, the set key is pressed, and “North-Up” is accepted by the system.

Alternatively, in order to input “NORTH-UP” via voice, the same items described above are sequentially input via voice. Specifically, “EDIT”, “SWITCH MAP”, “MAP VIEW”, and “NORTH-UP” are input via voice. “SET” is then input via voice, and “North-Up” is accepted by the system. It is noted that the talk switch TKS should be turned on before each item is spoken and entered via voice.

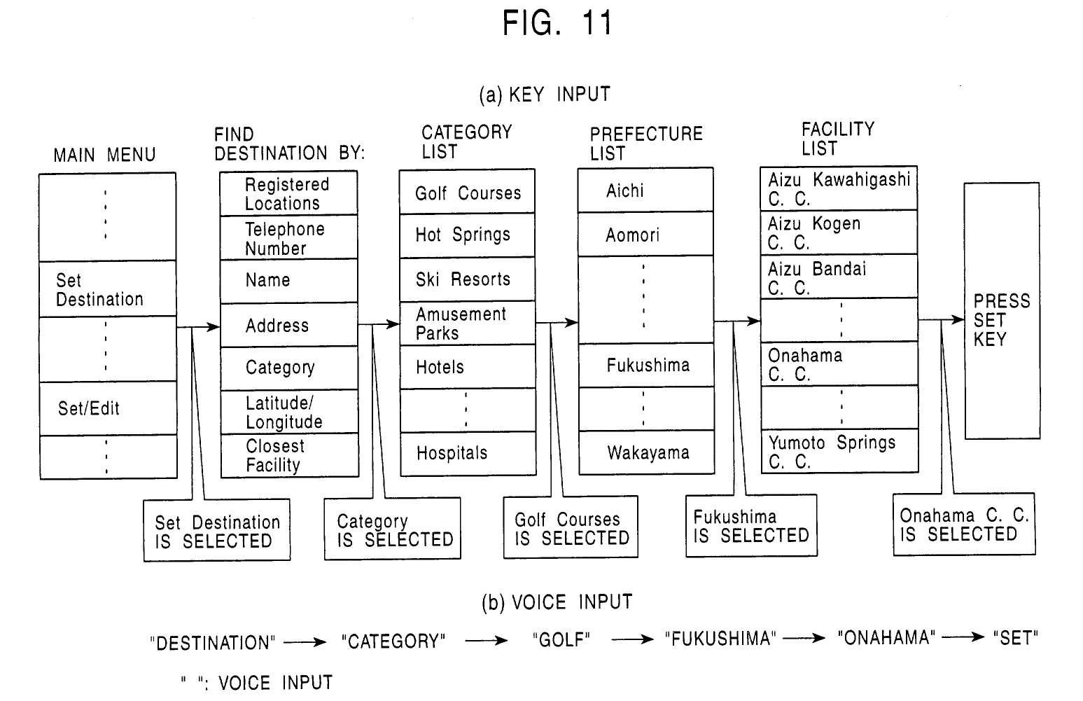

If “Set/Edit” is selected, therefore, information can be entered in the same way that a destination is entered as shown in FIG. 11. Accordingly, the information input methods according to the first through third embodiments described with reference to FIGS. 4 to 6 may be applied to the selection of “Set/Edit”.

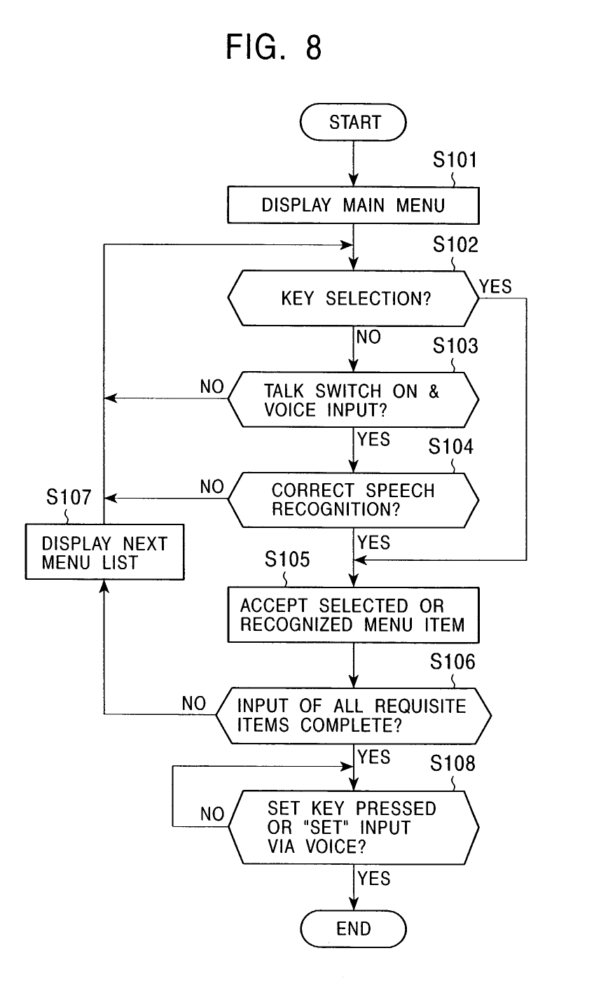

FIG. 8 shows an information input procedure according to the previously-described first embodiment.

The navigation control apparatus 1 displays a main menu on a screen of the display device 2 (step S101), and checks whether a certain item has been selected using a key selection or a certain item has been input via voice (steps S102 and S103). If an item has been input via voice after the talk switch TKS was turned on, the speech recognition apparatus 4 performs speech recognition to check whether or not the item has been correctly recognized (step S104). If the item has not been correctly recognized, the user is prompted to reenter the item, and the procedure returns to step S102 to repeat. If the item has been correctly recognized, or if the item has been selected using a key selection in step S102, the navigation control apparatus 1 accepts the selected item (step S105).

Then, it is determined whether or not input of all the requisite items is complete (step S106), and, if the input is not complete, a next menu list is displayed on the display device 2 (step S107), and the procedure returns to step S102 to repeat.

If the input of all the requisite items is complete in step S106, the set key is pressed or “SET” is input via voice (step S108), and the information input procedure ends.

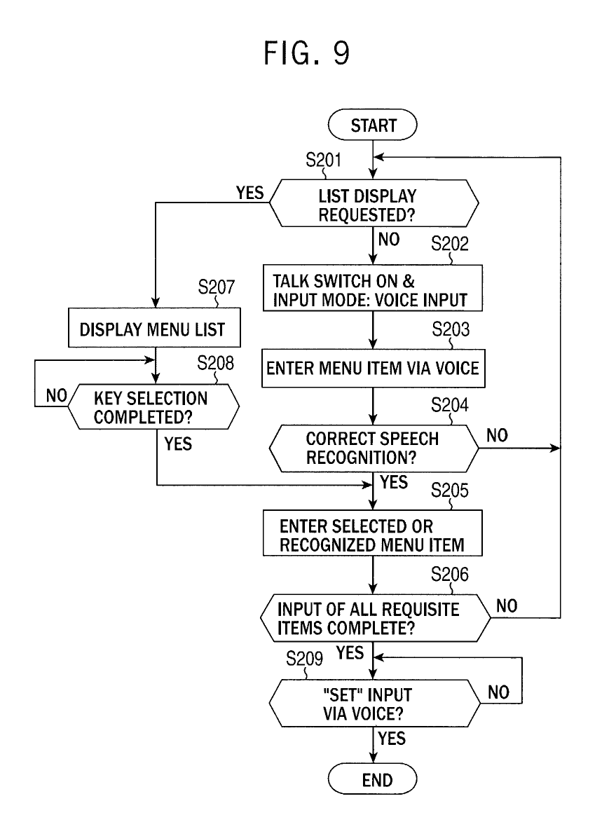

FIG. 9 shows an information input procedure according to the previously-described second embodiment.

In step S201, it is determined whether or not a request for list view has been issued. Since no request for list view has been issued initially, NO is obtained in step S201. In this case, in order to input an item via voice, the talk switch TKS is turned on, and the navigation control apparatus 1 switches the input mode to the voice-input mode (step S202). Then, an item is input via voice (step S203). The speech recognition apparatus 4 performs speech recognition, and checks whether or not the item has been correctly recognized (step S204). If the item has not been correctly recognized, a user is prompted to reenter the item, and the procedure returns to step S201 to repeat. If the item has been correctly recognized, the navigation control apparatus 1 accepts the item input via voice (step S205). Then, it is determined whether or not input of all the requisite items is complete (step S206), and, if the input is not complete, the procedure returns to step S201 to repeat.

If the item has not been correctly recognized, and the user requests for list view, the answer “YES” is obtained in step S201. Upon the request for list view, the navigation control apparatus I displays a menu list on the display device 2, and temporarily switches the input mode to the key-input mode (step S207). If a certain item is selected using a key selection in this mode (step S208), the navigation control apparatus 1 accepts the item selected using a key selection, and returns the input mode to the voice-input mode (step S205). Then, it is determined whether or not input of all the requisite items is complete (step S206), and, if the input is not complete, the procedure returns to step S201 to repeat.

If the input of all the requisite items is complete in step S206, “SET” is input via voice (step S209), and the information input procedure ends.

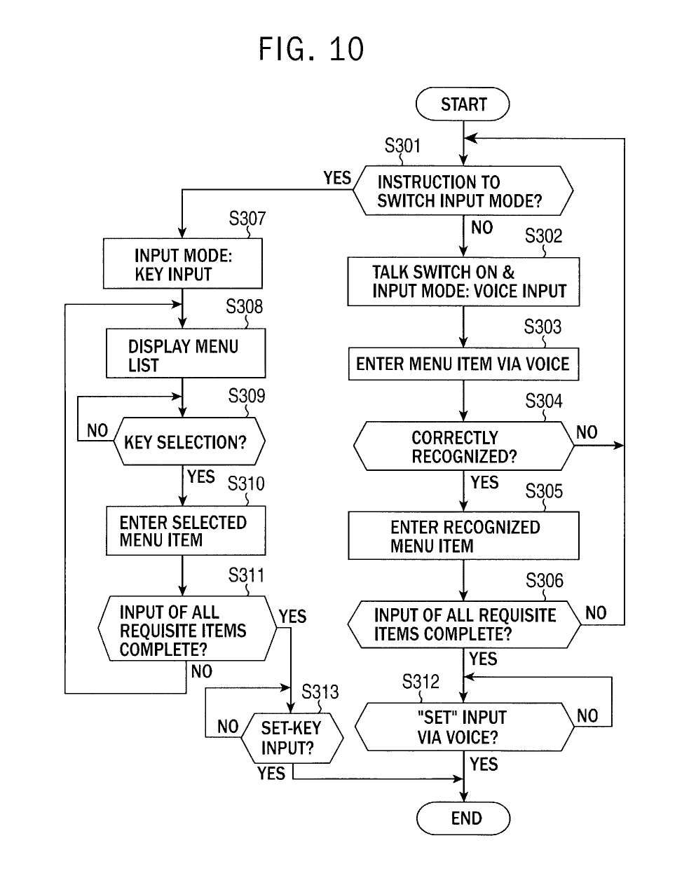

FIG. 10 shows an information input procedure according to the previously-described third embodiment.

In step S301, it is determined whether or not input-mode switching has been requested. Because the input-mode switching has not requested initially, “NO” is the answer obtained in step S301. In this case, in order to enter an item via voice, the talk switch TKS is turned on, and the navigation control apparatus 1 switches the input mode to the voice-input mode (step S302). Then, an item is input via voice (step S303). The speech recognition apparatus 4 performs speech recognition, and checks whether or not the item has been correctly recognized (step S304). If the item has not been correctly recognized, the user is prompted to re-enter the item, and the procedure returns to step S301 to repeat. If the item has been correctly recognized, the navigation control apparatus 1 accepts the item input via voice (step S305). Then, it is determined whether or not input of all the requisite items is complete (step S306), and, if the input is not complete, the procedure returns to step S301 to repeat.

If the item has not been correctly recognized, and the user requests for input-mode switching, the answer “YES” is obtained in step S301. Upon the input-mode switching request, the navigation control apparatus 1 switches the input mode to the key-input mode (step S307), and displays a menu list on the display device 2 (step S308). If an item is selected using a key selection in this mode (step S309), the navigation control apparatus 1 accepts the item selected using a key selection (step S310), and determines whether or not input of all the requisite items is complete (step S311). If the input is not complete, a next menu list is displayed on the display device 2 (step S308), and the procedure is repeated from step S309.

If the input of all the requisite items is complete in step S306, that is, if all items have been entered in the voice-input mode, “SET” is input via voice (step S312), and the information input procedure ends.

If the input of all the requisite items is complete in step S311, that is, if all items have been entered in the key-input mode, the set key is pressed (step S313), and the information input procedure ends.

Although the present invention has been described with reference to the specific embodiments described above, a variety of modifications and variations may be made without departing from the spirit and scope of the invention as defined in the appended claims, and it is not intended that the present invention exclude such modifications and variations.

1. An information input method for an apparatus having a key-input function that enables selection of an item from a displayed list of items using a key selection, and a voice-input function that enables selection of the item via voice input, the method comprising:
selecting a first item via a combination of the key input function and the voice input function; and
presenting a list of related items in response to selection of the first item.

2. An information input method according to claim 1, wherein the selected item comprises the address of a destination in a navigation system for determining the best guide route to the destination.

3. An information input method for an apparatus having a key-input mode in which an item is selected from a displayed list of items via a key selection, and a voice-input mode in which the item is selected via voice input, the method comprising:
allowing a user to request a list view in the voice-input mode;
displaying a list of items for key input in response to the request;
temporarily setting an input mode of the apparatus to the key-input mode;
receiving a selection input via the key-input mode; and
returning the input mode to the voice-input mode once an item has been selected from the presented list via the key-input mode.

4. An information input method according to claim 3, wherein the selected item comprises the address of a destination in a navigation system for determining the best guide route to the destination.

5. An information input method for an apparatus having a key-input mode in which an item is selected from a displayed list of items via a key selection, and a voice-input mode in which the item is selected via voice input, the method comprising:
allowing a user to request a list view in the voice-input mode;
displaying a list of items for key input in response to the request;
setting an input mode of the apparatus to the key-input mode;
receiving a selection input via the key input mode; and
returning the input mode to the voice-input mode in response to a voice input mode key selection.

6. An information input method according to claim 5, wherein the selected item comprises the address of a destination in a navigation system for searching the best guide route to the destination.

7. An information input apparatus having a key-input mode in which an item is selected from a displayed list of items via a key selection, and a voice-input mode in which the item is selected via voice input, the apparatus comprising:
means for outputting a request to temporarily switch the input mode from the voice-input mode to the key-input mode;
means for receiving a request in the voice-input mode to switch an input mode of the apparatus to the key-input mode;
means for switching the input mode from the voice-input mode to the key-input mode in response to the request;
means for presenting a list of items for key input; and
means for returning the input mode to the voice-input mode once an item has been selected from the presented list using a key selection.

8. An information input apparatus according to claim 7, wherein the means for outputting a request to switch the input mode generates the request when a voice-input request is detected.

9. An information input apparatus according to claim 7, wherein the list of items for key input includes an administrative district name.

10. An information input apparatus according to claim 7, wherein the selected item comprises the address of a destination in a navigation system for determining the best guide route to the destination.

11. An information input apparatus having a key-input mode in which an item is selected from a displayed list of items via a key selection, and a voice-input mode in which the item is selected via voice input, the apparatus comprising:
means for outputting a request to temporarily switch an input mode of the apparatus from the key-input mode to the voice-input mode; and
means for returning the input mode to the key-input mode once a selected item has been selected via the voice-input mode.

12. An information input apparatus according to claim 11, wherein the means for outputting a request to switch the input mode generates the request when a predetermined key is activated.

13. An information input apparatus according to claim 11, wherein the list of items for key input includes an administrative district name.

14. An information input apparatus according to claim 11, wherein the selected item comprises the address of a destination in a navigation system for determining the best guide route to the destination.

15. An information input apparatus having a key-input mode in which an item is selected from a displayed list of items via a key selection, and a voice-input mode in which the item is selected via voice input, the apparatus comprising:
means for outputting a request to switch an input mode of the apparatus from the voice-input mode to the key-input mode; and
means for switching the input mode from the voice-input mode to the key-input mode in response to a request received via the voice-input mode, wherein an item may be entered via key input after the input mode is switched to the key-input mode.

16. An information input apparatus according to claim 15, wherein the means for outputting a request to switch the input mode generates the request when a voice-input request is detected.

17. An information input apparatus according to claim 15, wherein the list of items for key input includes an administrative district name.

18. An information input apparatus according to claim 15, wherein the selected item comprises the address of a destination in a navigation system for determining the best guide route to the destination.

19. An information input apparatus having a key-input mode in which an item is selected from a displayed list of items via a key selection, and a voice-input mode in which the item is selected via voice input, the apparatus comprising:
means for outputting a request to switch the input mode from the key-input mode to the voice-input mode; and
means for switching an input mode of the apparatus from the key-input mode to the voice-input mode in response to a key-input request, wherein an item may be entered via voice input after the input mode is switched to the voice-input mode.

20. An information input apparatus according to claim 19, wherein the means for outputting a request to switch the input mode generates the request when a predetermined key is activated.

21. An information input apparatus according to claim 19, wherein the list of items for voice input includes an administrative district name.

22. An information input apparatus according to claim 19, wherein the selected item comprises the address of a destination in a navigation system for determining the best guide route to the destination.
